(19) United States
(12) Patent Application Publication
(10) Pub. No.: US 2016/0245344 A1
(43) Pub. Date: Aug. 25, 2016

(54) TWO PIECE CLUTCH REACTION PLATE

(71) Applicant: GM Global Technology Operations LLC, Detroit, MI (US)

(72) Inventor: SCOTT WILLIAM HEITZENRATER, ORION, MI (US)

(21) Appl. No.: 14/626,430

(22) Filed: Feb. 19, 2015

(51) Int. Cl. F16D 13/64; F16D 13/72

(52) U.S. Cl. CPC F16D 13/648; F16D 13/72

(57) ABSTRACT

Friction clutch reaction plate assemblies include two thin reaction plates which are preferably secured together in spaced relation to form a single reaction plate assembly. At least plate includes through openings which improve fluid flow between and around the plates and both plates include projections which align and define the spacing between the plates. The two plates may be secured together by various means such as spot welding, CD welding, laser welding, riveting or an adhesive. The axial space between the splines or teeth which couple the reaction plate to a clutch component (either a hub or a housing) may be reinforced with material to improve surface area contact. The reaction plate assembly has a thickness substantially equal to a conventional reaction plate in order that it may be readily substituted into current friction clutch assemblies.

### FIELD

The present disclosure relates to reaction plates for friction clutch assemblies and more particularly to two piece reaction plates for friction clutch assemblies.

### BACKGROUND

The statements in this section merely provide background information related to the present disclosure and may or may not constitute prior art.

Friction clutches, also referred to as friction clutch packs or friction clutch assemblies, are widely used in modern motor vehicle automatic transmissions. Friction clutches provide a modulatable torque transmitting device between two members rotating at different speeds or a rotating member and a stationary structure in which case the device is generally referred to as a brake. Such friction clutches and brakes comprise first and second interleaved pluralities of discs or plates that are coupled to respective first and second members, such as an input shaft and an output shaft or fixed member, and an actuator that compresses the plates or discs, thereby transmitting torque through the device.

The plates or discs are of two types: friction plates or discs are relatively thin metal and include bands or annuli of friction material on both surfaces. These friction plates or discs are interleaved with metal reaction plates which are thicker and do not include such friction material. All of the friction plates are coupled to, for example, an input member by splines and all of the reaction plates are coupled to, for example, an output member, also by splines.

As clutch torque throughput and heat dissipation requirements have increased on modern motor vehicle transmissions, so has the thickness of the clutch plates, particularly the reaction plates. Such thickness increases increase the mass and rotational inertia of such plates and of the overall transmission, thereby reducing the efficiency of the transmission and the fuel economy of the powertrain and vehicle.

It would therefore be desirable to reduce the mass of such reaction plates without compromising the function and heat transfer characteristics of thicker and more massive reaction plates. The present invention is so directed.

### SUMMARY

The present invention provides friction clutch reaction plate assemblies comprising two thin reaction plates which are preferably secured together to form a single reaction plate assembly. One or both plates include through axial openings which improve fluid flow in and around the plates and both plates include projections which align and establish the spacing between the plates. The two plates may be secured together by various means such as spot welding, CD welding, laser welding, rivets or an adhesive. The reaction plate assembly has a thickness substantially equal to a conventional, solid reaction plate in order that it may be readily substituted into current friction clutch designs. The axial space between the splines or teeth which couple the reaction plate to a clutch component (either a hub or a housing) may be filled or reinforced with plastic or epoxy to improve surface area contact. The space between the plates allows fluid flow there-between and provides improved heat transfer and thus improved reliability and service life.

Thus it is an aspect of the present invention to provide a friction clutch reaction plate assembly of conventional thickness which is assembled from two thin plates which define an annular space there-between.

It is a further aspect of the present invention to provide a friction clutch reaction plate assembly fabricated of two spaced apart reaction plates which are secured together.

It is a still further aspect of the present invention to provide a friction clutch reaction plate assembly fabricated of two spaced apart reaction plates which are secured together by spot welding, CD welding, laser welding, rivets or an adhesive.

It is a still further aspect of the present invention to provide a friction clutch reaction plate assembly fabricated of two spaced apart reaction plates one or both of which has axial openings which improve fluid flow in and around the plates.

It is a still further aspect of the present invention to provide a friction clutch reaction plate assembly fabricated of two spaced apart reaction plates one or both of which has axial projections which establish the spacing between the plates.

It is a still further aspect of the present invention to provide a friction clutch reaction plate assembly fabricated of two spaced apart reaction plates having a plastic or epoxy filler between the splines or teeth of the assembled reaction plate.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a sectional view of a friction plate clutch assembly incorporating the present invention;

FIG. 2 is a fragmentary perspective view of a two piece reaction plate assembly according to the present invention;

FIG. 3 is a full sectional view of a two piece reaction plate assembly according to the present invention taken along line 3-3 of FIG. 2, in pre-assembly configuration; and,

FIG. 4 is a fragmentary perspective view of a two piece reaction plate assembly according to the present invention illustrating the securement means and the material filler disposed between the teeth or splines.

### DETAILED DESCRIPTION

The following description is merely exemplary in nature and is not intended to limit the present disclosure, application, or uses.

With reference to FIG. 1, an exemplary friction clutch assembly is illustrated and generally designated by the reference number 10. The friction clutch assembly 10 may be a component of, for example an automatic transmission, a transfer case or other power and torque controlling and transmitting device. The friction clutch assembly 10 is disposed between a rotating hub 12 having a set of axially extending male splines 14. The hub 10 includes a radially and circumferentially extending flange 16 which may be connected to a rotating shaft, quill or a member of another clutch or brake (all not illustrated). A plurality of friction plates or discs 20 having female splines 22 about their inner edges are complementary to the male splines 14 on the hub 12. The female splines 22 engage the male splines 14 on the hub 12 and thus the plurality of friction plates or discs 20 rotate with the hub 12. Each face of the plurality of friction plates or discs 20 includes a band or annulus of friction material 24 which is secured thereto by an adhesive or in a similar manner.

Interleaved with the plurality of friction plates or discs 20 is a plurality of reaction plate assemblies 30. The reaction plate assemblies 30 include male splines 32 about their outer peripheries and may be fabricated of either steel or aluminum. As will be described in more detail below, each of the plurality of reaction plate assemblies 30 includes a first reaction plate 34A and a second reaction plate 34B separated by an annular space 36. The male splines 32 are complementary to and engage female splines 38 extending axially along an inner surface of a housing 40 or other structure.

At one end of the friction clutch assembly 10, the housing 40 includes an inwardly extending web of flange 42 terminating in a radially extending surface 44 that acts as a stop for a circular backing plate 46. At the opposite end of the friction clutch assembly 10 is disposed an apply plate 48 which is acted upon by a piston or an actuator member 52 of a hydraulic, electric or pneumatic actuator or operator 54. In accordance with conventional practice, when the actuator or operator 54 is energized, the piston or actuator member 52 extends, applies pressure to and translates the apply plate 46 which, in turn, applies pressure to the pluralities of friction plates 20 and reaction plates 30, thereby frictionally connecting and, if a speed difference exists, transferring torque between the hub 12 and the housing 40. It should be appreciated that the foregoing description is illustrative only and that variations such as a fixed or stationary hub 12 and rotating housing 40 as well as friction plates 20 splined to the outer housing 40 and reaction plates 30 splined to the inner hub 12 are all within the purview of the present invention.

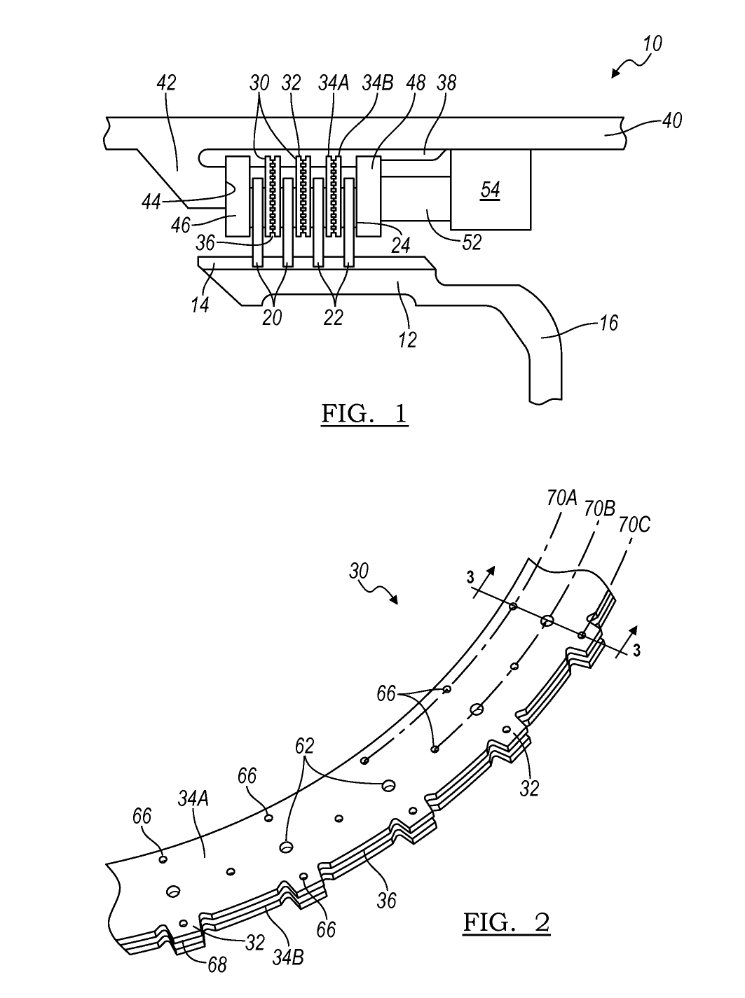

Referring now to FIGS. 2, 3 and 4, the first reaction plate 34A and the second reaction plate 34B are both preferably approximately 0.8 mm. (0.0315 in.) thick and the annular space 36 there-between is also approximately 0.8 mm. for a total thickness of approximately 2.4 mm. (0.0945 in.). This thickness (2.4 mm.) is a typical thickness for a conventional (solid) reaction plate and thus the reaction plate assembly 30 according to the present invention may readily replace conventional reaction plates without modification to the friction clutch assembly while enjoying a mass reduction of approximately 33%. It should be understood, however, that both the plate thickness and the ratio of the plate and space thicknesses may be varied to accommodate and satisfy various applications without departing from the scope of this invention.

Each of the first reaction plates 34A and the second reaction plates 34B includes a plurality of male splines 32 about their peripheries. Each of the first reaction plates 34A and the second reaction plates 34B also preferably includes a plurality of spaced apart through oil and/or air openings 62 arrayed in a circle disposed approximately in the middle of the reaction plates 34A and 34B. While the number of openings 62 will vary depending upon their size and the size of the reaction plates 34A and 34B, it has been found that between twelve and thirty openings 62 has proven functional with between twenty and twenty-six openings 62 being preferred. The through openings 62 allow oil to pass in and out of the friction interfaces and the annular space 36 between the plates 34A and 34B. The through openings 62 also allow air to enter the friction interfaces when the friction clutch assembly 10 is released, thereby more quickly reducing drag.

Each of the first reaction plates 34A further includes a plurality of upset or partially pierced openings which create recesses 66 on the outer surfaces of the reaction plates 34A and a first plurality of pads, lugs or projections 68A on the inner surface which extend half way across the annular space 36 and contact a second and like plurality of correspondingly located pads, lugs or projections 68B on the inner surfaces of each of the second reaction plates 34B. The second plurality of lugs or projections 68B likewise extend half way across the annular space 36 and are also upset or partially pierced openings which create recesses 66 on the outer surfaces of the second reaction plates 34B and the lugs or projections 68B on the inner surfaces. With reference to the width (0.8 mm.) of the annular space 36 given in the example above, each of the lugs or projections 68A and 68B has a height of 0.4 mm. (0.0157 in.).

The lugs or projections 68A and 68B establish the desired spacing between the first reaction plates 34A and the second reaction plates 34B. Accordingly, they are preferably formed in a die with blind holes having flat bottoms in order that they have both accurately flat end surfaces and heights. Alternatively, after being formed by, for example, piercing or upsetting, the end surfaces of the lugs or projections 68A and 68B may be finished by grinding.

The plurality of partially pierced openings forming the recesses 66 and the lugs or projections 68A and 68B are preferably arrayed in inner circles designated by a dashed line 70A adjacent the inner edge of the reaction plates 34A and 34B, intermediate circles designated by a dashed line 70B where they alternate with the through openings 62 and outer circles designated by a dashed line 70C which passes generally through the splines 32. The recesses 66, best illustrated in FIG. 4, created by the partial piercing are beneficial as they reduce spin losses by allowing air to be introduced into the friction interfaces when the friction clutch assembly 10 is released.

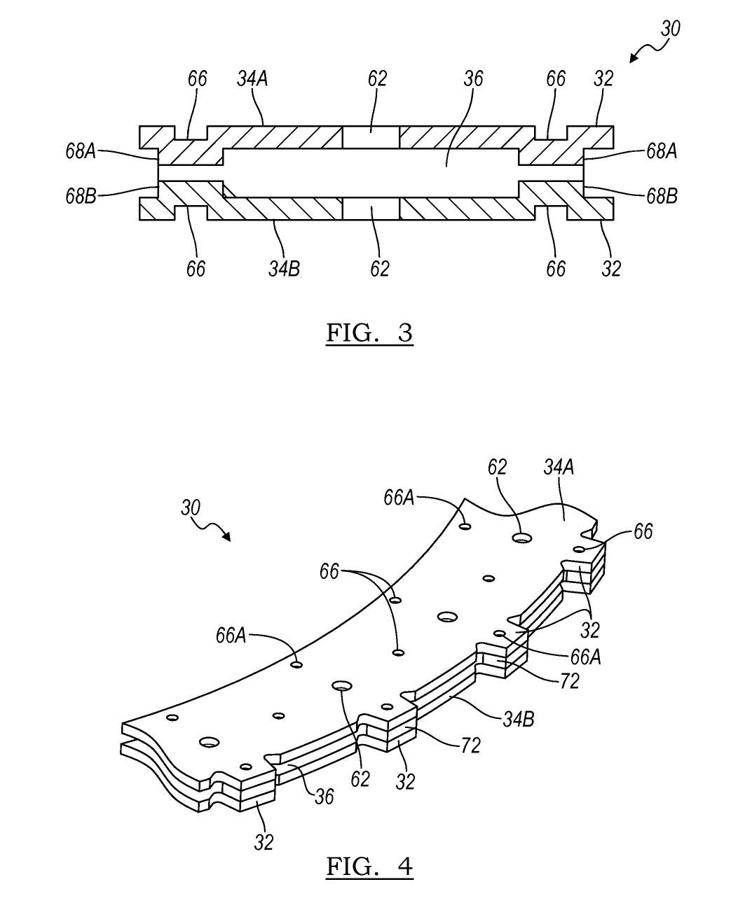

Referring now to FIGS. 3 and 4, the first reaction plate 34A is placed adjacent the second reaction plate 34B with the lugs or projections 68A of the first reaction plate 34A facing or extending toward, and aligning with, the lugs or projections 68B on the second reaction plate 34B and the splines 32 on each of the plates 34A and 34B axially aligned. So arranged, the reaction plate assemblies 30 may be installed within a friction clutch such as the friction clutch assembly 10. For various applications, however, it may be desirable to secure the first reaction plates 34A to respective second reaction plates 34B. This may be readily accomplished by spot welding, laser welding or discharge (CD) welding, preferably at a certain number of the recesses 66A (and the lugs or projections 68A and 68B) spaced about the plates 34A and 34B. Alternatively, other welding techniques or adhesive bonding may be utilized. As a further alternative, the plates 34A and 34B may be riveted together with either separate rivets or parent material rivets also illustrated at 66A.

Referring now to FIG. 4, in order to achieve optimum spline contact area, it may be desirable to fill the space between the splines 32 of the reaction plates 34A and 34B with a plastic or epoxy material 72. Alternatively, one or both of the reaction plates 34A and 34B may be stamped or extruded in the region of the splines 32 to allow for full metal thickness at the splines 32, i.e., 2.4 mm. in the example given above, again to improve spline contact area. Finally, with reaction plate assemblies 30 having welded or otherwise secured plates 34A and 34B, it may be desirable to re-stamp the splines 32 to ensure optimum and uniform surface contact with a mating housing such as the outer housing 40.

Thus it will be appreciated that a friction clutch assembly 10 incorporating reaction plate assemblies 30 according to the present invention achieves a reaction plate mass reduction of approximately 33%, may have reaction plates of steel or aluminum, has lower inertia, better cooling, lower spin losses and achieves improved air and oil flow through the clutch as discussed above.

The description of the invention is merely exemplary in nature and variations that do not depart from the gist of the invention are intended to be within the scope of the invention. Such variations are not to be regarded as a departure from the spirit and scope of the invention.

What is claimed is:

1. A reaction plate assembly for a friction clutch comprising, in combination,
a first reaction plate having a plurality of first teeth about one of an inner and an outer periphery, a plurality of openings extending through said first plate and a first plurality of projections extending from a first inner surface,
a second reaction plate spaced from said first reaction plate, having a plurality of second teeth about one of an inner and an outer periphery, and a second plurality of projections extending from a second inner surface and aligned with said first plurality of projections, and
means for connecting said first reaction plate to said second reaction plate.

2. The reaction plate assembly of claim 1 further including material disposed between said plurality of first teeth and said plurality of second teeth.

3. The reaction plate assembly of claim 2 wherein said material is one of a plastic or an epoxy.

4. The reaction plate assembly of claim 1 wherein said means for connecting is one of spot welds, CD welds, laser welds and an adhesive.

5. The reaction plate assembly of claim 1 wherein each of said plates is approximately 0.8 mm. in thickness.

6. The reaction plate assembly of claim 1 wherein a thickness of each of said plates and a separation between said plates is substantially equal.

7. The reaction plate assembly of claim 1 further including an additional plurality of openings extending through said second plate.

8. A reaction plate assembly for a friction clutch comprising, in combination,
a first metal reaction plate having a first side surface, a plurality of first splines about a first edge, a plurality of openings extending through said first metal reaction plate and a plurality of first projections extending from said first side surface, and
a second metal reaction plate spaced from said first metal reaction plate and having a second side surface, a plurality of second splines about a second edge and a plurality of second projections extending from said second side;
whereby said first and said second metal reaction plates are spaced apart by alignment of said plurality of first projections with said plurality of second projections.

9. The reaction plate assembly of claim 8 wherein said metal is one of steel and aluminum.

10. The reaction plate assembly of claim 8 further including a plurality of recesses in another side surface of first metal reaction plate and in another side surface of said second metal reaction plate.

11. The reaction plate assembly of claim 10 wherein said plurality of recesses are axially aligned with said plurality of projections.

12. The reaction plate assembly of claim 8 further including material disposed between said plurality of first splines and said plurality of second splines.

13. The reaction plate assembly of claim 8 further including an additional plurality of openings extending through said second metal reaction plate.

14. A reaction plate assembly for a friction clutch comprising, in combination,
a first metal reaction plate having a first side surface, a plurality of first splines about one edge, a plurality of first openings extending through said first metal reaction plate and a plurality of first projections extending from said first side surface, and
a second metal reaction plate axially spaced from said first metal reaction plate and having a second side surface, a plurality of second splines about one edge, a plurality of second openings extending through said second metal reaction plate and a plurality of second projections extending from said second side surface and aligned with said first projections,
wherein said first metal reaction plate is secured to said second metal reaction plate at a portion of said plurality of projections.

15. The reaction plate assembly of claim 14 wherein said metal is one of steel and aluminum.

16. The reaction plate assembly of claim 14 further including a plurality of recesses in another side surface of first metal reaction plate and in another side surface of said second metal reaction plate.

17. The reaction plate assembly of claim 16 wherein said plurality of recesses are axially aligned with said plurality of projections.

18. The reaction plate assembly of claim 14 further including material disposed between said plurality of first splines and said plurality of second splines.

19. The reaction plate assembly of claim 14 wherein a thickness of each of said metal reaction plates and a separation between said plates is substantially equal.
